(19) United States
(12) Patent Application Publication
(10) Pub. No.: US 2015/0362001 A1
(43) Pub. Date: Dec. 17, 2015

(54) COOLANT SUCTION DEVICE AND MACHINE TOOL

(71) Applicant: MITSUBISHI HEAVY INDUSTRIES, LTD., Minato-ku, Tokyo (JP)

(72) Inventors: Shingo NAKAMURA, Tokyo (JP); Takahiro SERIGANO, Tokyo (JP)

(73) Assignee: MITSUBISHI HEAVY INDUSTRIES, LTD., Tokyo (JP)

(21) Appl. No.: 14/758,448

(22) PCT Filed: Jan. 20, 2014
(86) PCT No.: PCT/JP2014/050892

§ 371 Date: Jun. 29, 2015

(30) Foreign Application Priority Data
Feb. 7, 2013 (JP) 2013-022092

(51) Int. Cl. F15D 1/02; B23Q 11/10; B23Q 11/00

(52) U.S. Cl. CPC F15D 1/02; B23Q 11/0046; B23Q 11/1015

(57) ABSTRACT

Provided is a coolant suction device that can collect a coolant remaining in a supply pipe while preventing an ejector from breaking down. The coolant suction device comprises: a gas supply source (21) that supplies a gas; an ejector (24), the input side of which is connected to the gas supply source (21) via a valve (22); a primary receiving tank (25), the upper part of which is connected to the negative-pressure side of the ejector (24); a suction pipe (T5), one end of which is connected to the upper part of the primary tank (25) and the other end of which is connected to a supply pipe (P2a) via a valve (28a); and a check valve (27) that is connected to the bottom part of the primary receiving tank (25) and that only opens downward. When the valve (22) and the valve (28a) are opened, a gas is supplied from the gas supply source (21) to the ejector (24), negative pressure is created inside the primary receiving tank (25) by the ejector (24), and a coolant (C) remaining in the supply pipe (P2a) is sucked into the primary receiving tank (25) via the suction pipe (T5).

### TECHNICAL FIELD

The present invention relates to a coolant suction device of a machine tool having a coolant discharge function and a machine tool including the coolant suction device.

### BACKGROUND ART

In machining using a machine tool, regardless of water solubility or oiliness, a coolant is widely used. Moreover, in a machine tool which includes an automatic tool changer, in addition to a structure in which a coolant is supplied from a nozzle to a work material, in many cases, a spindle-through structure in which the coolant passes through a tool is adopted. Also in any structure, if the coolant remaining in a pipe is not removed after supply of the coolant is stopped, the coolant may leak outside the machine when a main shaft moves, or a problem such as biting may occur due to minute chips being mixed into the coolant when the tool is changed.

### CITATION LIST

### Patent Literature

[PTL 1] Japanese Unexamined Patent Application Publication No. 8-118198 (FIG. 1)

[PTL 2] Japanese Unexamined Patent Application Publication No. 11-165235 (FIG. 1)

### SUMMARY OF INVENTION

### Technical Problem

In the related art, as a method for removing a coolant remaining in a pipe, there are two methods such as a method of blowing off the coolant by air blow and a method of sucking the coolant. In the method of blowing off the coolant, since foggy coolant floats around the machine, there is a problem in that health problems or contamination of the machine or a building may occur.

Meanwhile, as the method of sucking the coolant, for example, technologies disclosed in PTLs 1 and 2 are known. However, the following problems exist in PTLs 1 and 2. For example, PTL 1 discloses a structure in which a path of a coolant discharged from a pump is switched by a valve so that the coolant passes through an ejector to generate negative pressure, and the coolant remaining in a pipe is sucked (refer to FIG. 1). However, in this structure, since the coolant needs to pass through the inner portion of the ejector, there is a concern that minute chips or a deteriorated coolant may be clogged, and a breakdown may occur.

The present invention is made in consideration of the above-described problems, and an object thereof is to provide a coolant suction device and a machine tool capable of collecting a coolant remaining in a supply pipe while preventing an ejector from breaking down.

### Solution to Problem

According to a first invention for achieving the above-described object, there is provided a coolant suction device that sucks a coolant remaining in a supply pipe after the coolant is supplied to the supply pipe of a machine tool that discharges the coolant, including: a gas supply source that supplies a gas; an ejector that includes an input side connected to the gas supply source via a first valve; a primary receiving container that includes an upper part connected to a negative-pressure side of the ejector; a suction pipe that includes one end connected to the upper part of the primary receiving container and the other end connected to the supply pipe via a second valve; and a non-return valve that is connected to a bottom part of the primary receiving container and opens below the primary receiving container, in which the first valve and the second valve are open, the gas is supplied from the gas supply source to the ejector, negative pressure is created inside the primary receiving container by the ejector, and the coolant remaining in the supply pipe is sucked into the primary receiving container via the suction pipe.

In a second invention for achieving the above-described object, in the coolant suction device according to the first invention, when the first valve and the second valve are closed, the inner portion of the primary receiving container may return to the atmospheric pressure, the non-return valve may open by the weight of the coolant itself sucked into the primary receiving container, and the coolant may be discharged downward.

In a third invention for achieving the above-described object, in the coolant suction device according to the first or second invention, a storage container that stores the sucked coolant may be provided below the non-return valve.

In a fourth invention for achieving the above-described object, in the coolant suction device according to any one of the first to third inventions, a filter that separates gas and liquid may be provided on an output side of the ejector.

In a fifth invention for achieving the above-described object, in the coolant suction device according to any one of the first to fourth inventions, volume of the primary receiving container may be larger than capacity inside the supply pipe.

According to a sixth invention for achieving the above-described object, there is provided a machine tool including the coolant suction device according to any one of the first to fifth inventions.

### Advantageous Effects of Invention

According to the present invention, since a gas is used to drive an ejector and it is not necessary to cause a coolant to pass through the inner portion of the ejector, minute chips or a deteriorated coolant is not clogged inside the ejector, and it is possible to decrease a breakdown probability of the ejector.

### BRIEF DESCRIPTION OF DRAWINGS

FIG. 1 is a system diagram showing an example of an embodiment of a coolant suction device according to the present invention.

FIG. 2 is a diagram for explaining suction of a coolant from a supply pipe with reference to the system diagram shown in FIG. 1.

### DESCRIPTION OF EMBODIMENTS

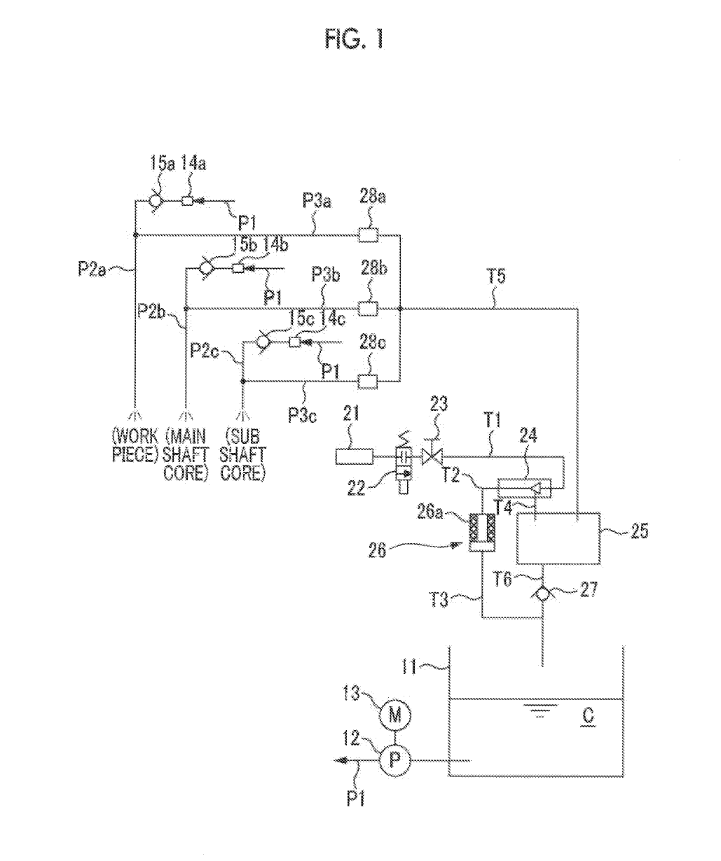

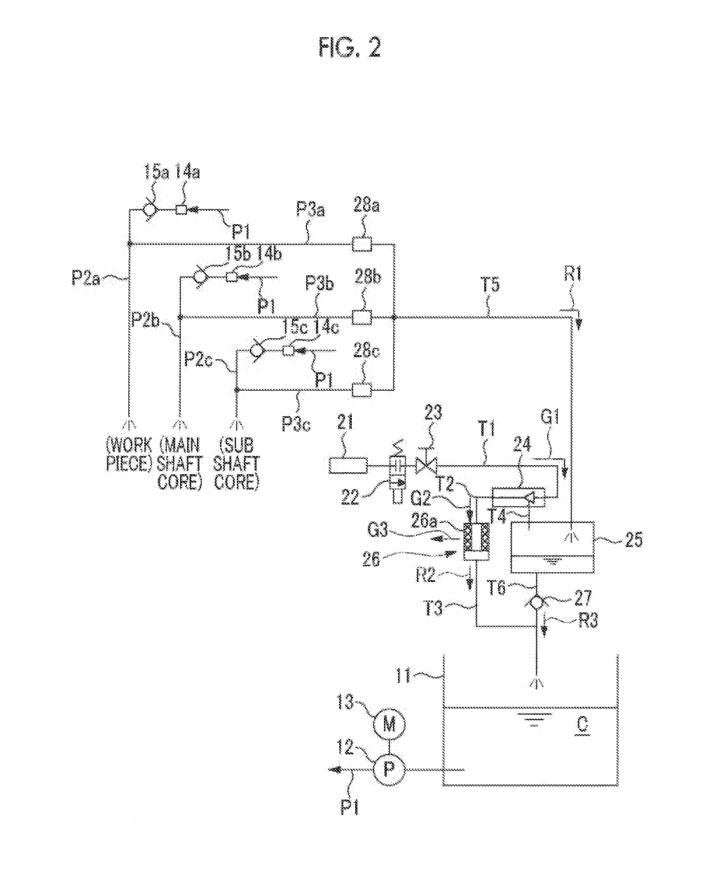

Hereinafter, embodiments of a coolant suction device and a machine tool according to the present invention will be described with reference to FIGS. 1 and 2.

### Embodiment 1

FIG. 1 is a system diagram showing a coolant suction device according to the present embodiment, and FIG. 2 is a diagram for explaining suction of a coolant from a supply pipe with reference to the system diagram shown in FIG. 1.

The coolant suction device of the present embodiment is used in a machine tool having a coolant discharge function, and sucks a coolant remaining in a supply pipe after discharging of the coolant stops to prevent the coolant from being leaked.

First, the discharging of the coolant will be described with reference to FIG. 1. A storage tank 11 which stores a used coolant C is provided in a machine tool (not shown), and the coolant C is supplied to the machine tool using a pipe P1 connected to the storage tank 11 and a pump 12 and a motor 13 attached to the pipe P1.

For example, the coolant C is supplied to three locations such as a work piece, a main shaft core, and a sub shaft core (for example, an attachment or the like) of the machine tool, and when the coolant C is discharged, three supply pipes P2a to P2c are connected to the pipe P1. A valve 14a and a check valve 15a are connected to the supply pipe P2a for the work piece, a valve 14b and a check valve 15b are connected to the supply pipe P2b for the main shaft core, and a valve 14c and a check valve 15c are connected to the supply pipe P2c for the sub shaft core. The number of the supply systems can be appropriately increased or decreased according to the locations for discharging the coolant needed in the machine tool.

For example, when the coolant C is supplied to the work piece to be discharged, the valve 14a is opened by the control of a control device (not shown), and the coolant C is supplied to the work piece via the supply pipe P2a and is discharged. Similarly, when the coolant C is supplied to the main shaft core to be discharged, the valve 14b is opened by the control of the control device, and the coolant C is supplied to the main shaft core via the supply pipe P2b and is discharged. In addition, when the coolant C is supplied to the sub shaft core to be discharged, the valve 14c is opened by the control of the control device, and the coolant C is supplied to the sub shaft core via the supply pipe P2c and is discharged.

In the supply pipes P2a to P2c, branching pipes are respectively connected to the downstream sides of the check valves 15a to 15c, and the coolants remaining inside the supply pipes P2a to P2c on the downstream sides of the check valves 15a to 15c can be sucked by the coolant suction device described below. Since cracking pressures of the check valves 15a to 15c are greater than pressure (negative pressure) generated by suction of the coolant suction device described below, the check valves 15a to 15c are not open while the coolant is being sucked.

Next, the coolant suction device of the present embodiment will be described. The coolant suction device of the present embodiment also uses an ejector 24. An input pipe T1 is connected to the input side of the ejector 24, a gas supply source 21 for supplying a gas such as air (compressed air or the like) or gas (nitrogen, oxygen, or the like), a valve 22 for supplying the gas from the gas supply source 21 or stopping the supply of the gas, and an manual valve 23 for adjusting pressure or a flow rate of the supplied gas are connected to the input pipe T1.

Moreover, the output side of the ejector 24 may open to the atmosphere. However, here, an output pipe T2 is connected to the output side of the ejector 24, a filter 26 which separates gas and liquid is connected to the output pipe T2, a discharge pipe T3 is connected to the lower part of the filter 26, and the discharge pipe T3 is joined with a discharge pipe T6 described below.

In addition, a negative-pressure pipe T4 is connected to the negative-pressure side of the ejector 24, and the negative-pressure pipe T4 is connected to an upper part of a primary receiving tank 25. In addition, one end of a suction pipe T5 is connected to the upper part of the primary receiving tank 25, and the other end of the suction pipe T5 is connected to each of the branching pipes P3a to P3c via each of valves 28a to 28c. Moreover, a discharge pipe T6 is connected to the bottom part of the primary receiving tank 25, a check valve 27 which only opens downward is connected to the discharge pipe T6, the discharge pipe T3 and the discharge pipe T6 are joined with each other at the downstream side of the check valve 27, and a discharge port of the joined portion is disposed above the storage tank 11.

The coolant remaining inside the supply pipes P2a to P1c is sucked using the coolant suction device configured as described above. Here, with reference to FIG. 2, the suction of the coolant C remaining inside the supply pipe P2a will be described.

As described above, when the coolant C is supplied to the work piece to be discharged, the valve 14 is opened by the control of the control device, and the coolant C is supplied to the work piece via the supply pipe P2a and is discharged. Since the coolant C remains inside the supply pipe P2a after the discharging of the coolant C stops, the valve 28a and the valve 22 are opened by the control of the control device in order to suck the coolant C.

If the valve 22 is open, the gas is supplied from the gas supply source 21 to the ejector 24 via the input pipe T1 (flow G1 of gas). If the liquid such as the gas is supplied to the ejector 24, the fluid is ejected at a high speed from a nozzle provided inside the ejector 24, negative pressure is generated by an entrainment effect of the ejected fluid, and thus, other fluid is sucked by the generated negative pressure and can be discharged. The negative-pressure pipe T4 of the ejector 24 is connected to the primary receiving tank 25, and the ejector 24 sucks the air inside the primary receiving tank 25 and discharges the air.

When the air inside the primary receiving tank 25 is sucked and discharged by the ejector 24, the inner portion of the primary receiving tank 25 also is in a negative-pressure state. Although the check valve 27 is connected to the discharge pipe T6 connected to the bottom portion of the primary receiving tank 25, if the inner portion of the primary receiving tank 25 is in the negative-pressure state, since the upstream side of the check valve 27 reaches a negative pressure (pressure smaller than the atmospheric pressure) and the downstream side of the check valve 27 reaches the atmospheric pressure, a state where the check valve 27 is closed is maintained. Even when the inner portion of the primary receiving tank 25 is in the negative-pressure state by the check valve 27, the surrounding atmosphere or the coolant C does not return to the primary receiving tank 25 from the discharge pipe T6 side.

Accordingly, when the inner portion of the primary receiving tank 25 is in the negative-pressure state, the coolant C remaining inside the supply pipe P2a is sucked via the suction pipe T5 connected to the upper part of the primary receiving tank 25, the valve 28a, the branching pipe P3a, and the coolant C is collected inside the primary receiving tank 25 (a flow R1 of the coolant C). In addition, the collected coolant C is temporarily stored inside the primary receiving tank 25.

In this case, since the pressure and the flow rate of the gas supplied from the gas supply source 21 are constant, capacity (capacity of the remaining coolant C) inside the supply pipe P2a is obtained in advance, and if a time for collecting the obtained capacity is obtained, it is possible to securely and stably collect the remaining coolant C.

As described above, here, the filter 26 is connected to the output pipe T2. If the inner portion of the primary receiving tank 25 is set to the negative-pressure state by the ejector 24 and the coolant C remaining inside the supply pipe P2a is collected at the primary receiving tank 25, the coolant C is atomized in the inner portion of the primary receiving tank 25 by the force of the sucked coolant C, and thus, mist may be generated. When the mist is generated inside the primary receiving tank 25, the mist is discharged to the output pipe T2 side through the negative-pressure pipe T4 (a flow G2 of the mist).

Therefore, gas and liquid are separated by the filter 26 connected to the output pipe T2, and the separated gas is discharged to the atmosphere through a mesh portion 26a of the filter 26 (a flow G3 of the gas). Meanwhile, the separated coolant C returns to the storage tank 11 via the discharge pipe T3 connected to the lower part of the filter 26 (a flow R2 of the coolant C). In this way, even when the coolant C becomes mist, the mist is not leaked to the atmosphere due to the filter 26.

As described above, the negative pressure is generated in the ejector 24 using the gas supplied from the gas supply source 21, and thus, the coolant C does not flow to the inner portion (particularly, the nozzle which generates the negative pressure) of the ejector 24. If the mist of the collected coolant C is generated inside the primary receiving tank 25, the mist only flows to the vicinity of the nozzle. Accordingly, unlike PTLs 1 and 2, clogging does not occur in the nozzle, and it is possible to decrease a breakdown probability.

After the remaining coolant C is collected inside the primary receiving tank 25, when the valve 28a and the valve 22 are closed by the control of the control device, that is, when the supply of the gas from the gas supply source 21 stops, the inner portion of the primary receiving tank 25 returns to the atmospheric pressure state. If so, the check valve 27 is opened by the weight of the coolant C itself collected inside the primary receiving tank 25, and thus, the coolant C is automatically collected in the storage tank 11 via the discharge pipe T6 (a flow R3 of the coolant C). The cracking pressure of the check valve 27 may be set so that the check valve 27 is opened by the weight of the coolant C itself. In this way, here, in order to return the coolant C from the primary receiving tank 25 to the storage tank 11 using the own weight of the coolant C, a positional relationship between the primary receiving tank 25 and the storage tank 11 is set so that the primary receiving tank 25 is positioned at the upper portion and the storage tank 11 is positioned at the lower portion.

In this way, if the valve 28a and the valve 22 are open and the ejector 24 is operated, the coolant C remaining inside the supply pipe P2a is sucked and is collected inside the primary receiving tank 25. Thereafter, if the valve 28 and the valve 22 are closed, the coolant C collected inside the primary receiving tank 25 returns to the storage tank 11.

This is similarly applied to a case where the coolant C remaining inside the supply pipe P2b or the supply pipe P2c is sucked and collected, the valve 28b may open and close along with the valve 22 in the case of the supply pipe P2b, and the valve 28c may open and close along with the valve 22 in the case of the supply pipe P2c.

In addition, the capacity (the capacity of the remaining coolant C) inside the supply pipe P2a is obtained in advance, and the volume of the primary receiving tank 25 is set to be larger than the obtained capacity. If the coolant C remaining inside the supply pipe P2b or the supply pipe P2c is sucked and collected along with the coolant C remaining inside the supply pipe P2a, or the coolant C remaining inside both the supply pipe P2b and the supply pipe P2c is sucked and collected along with the coolant C remaining inside the supply pipe P2a, the capacities of the supply pipes are obtained to be summed, and the volume of the primary receiving tank 25 may be set to be larger than the summed capacities.

In addition, since a pressure (for example, approximately 3 Mpa) required for the discharging is applied to the pipes P1 to P3 when the coolant C is discharged, the pipes P1 to P3 need to be high-pressure pipes capable of enduring the pressure. However, the pipes related to the suction of the coolant C, specifically, the pipes T1 to T5 need not be high-pressure pipes since the pipes are not related to the discharge of the coolant C. The corresponding pressure range of each of the pipes T1 to T5 may be a range between the negative pressure and the supply pressure (for example, approximately 0.5 MPa) of the gas.

In the devices shown in PTLs 1 and 2, there are concerns that the following problems may occur in addition to the breakdown of the ejector. For example, in the devices shown in PTLs 1 and 2, a suction force of the ejector is dependent on characteristics such as the discharge pressure of the pump. In addition, since the pump for discharging the coolant is used as it is and the coolant is supplied to the ejector by switching the supply paths of the coolant, the supply pressure of the coolant applied to the ejector is not appropriate, and waste in the amount of power consumption of the pump increases. In addition, the pipe for sucking the coolant also needs to be a high-pressure pipe to endure the supply pressure of the coolant. In addition, since it is necessary to supply a large amount of coolant to drive the ejector and to collect the used coolant in the tank, mist may be also generated in the tank which collects the coolant.

On the other hand, in the coolant suction device of the present embodiment, as described above, since the gas is used to drive the ejector, it is possible to decrease the breakdown probability, to stabilize the suction force of the ejector, and to decrease the waste based on the amount of power consumption. In addition, the pipe for sucking the coolant need not be the high-pressure pipe, and it is possible to prevent occurrence of the mist since it is enough to only collect the coolant remaining in the pipe.

### INDUSTRIAL APPLICABILITY

The present invention is suitable for a machine tool having a coolant discharge function.

### REFERENCE SIGNS LIST

11: storage tank (storage container)

12: pump

21: gas supply source

22: valve (first valve)

24: ejector

25: primary receiving tank (primary receiving container)

26: filter

27: check valve (non-return valve)

28a to 28c: valve (second valve)

1. A coolant suction device that sucks a coolant remaining in a supply pipe after the coolant is supplied to the supply pipe of a machine tool that discharges the coolant, comprising:
a gas supply source that supplies a gas;
an ejector that includes an input side connected to the gas supply source via a first valve;
a primary receiving container that includes an upper part connected to a negative-pressure side of the ejector;
a suction pipe that includes one end connected to the upper part of the primary receiving container and the other end connected to the supply pipe via a second valve; and
a non-return valve that is connected to a bottom part of the primary receiving container and opens below the primary receiving container,
wherein the first valve and the second valve are open, the gas is supplied from the gas supply source to the ejector, negative pressure is created inside the primary receiving container by the ejector, and the coolant remaining in the supply pipe is sucked into the primary receiving container via the suction pipe.

2. The coolant suction device according to claim 1,
wherein when the first valve and the second valve are closed, the inner portion of the primary receiving container returns to the atmospheric pressure, the non-return valve is opened by the weight of the coolant itself sucked into the primary receiving container, and the coolant is discharged downward.

3. The coolant suction device according to claim 1,
wherein a storage container that stores the sucked coolant is provided below the non-return valve.

4. The coolant suction device according to
claim 1, wherein a filter that separates gas and liquid is provided on an output side of the ejector.

5. The coolant suction device according to
claim 1, wherein volume of the primary receiving container is larger than capacity inside the supply pipe.

6. A machine tool comprising the coolant suction device according to claim 1.
